(19) United States
(12) Patent Application Publication
(10) Pub. No.: US 2012/0290544 A1
(43) Pub. Date: Nov. 15, 2012

(54) DATA COMPLIANCE MANAGEMENT

(75) Inventors: Tamer E. Abuelsaad, Poughkeepsie, NY (US); Thomas E. Cook, Essex Junction, VT (US); Kevin C. McConnell, Austin, TX (US); Alan P. Mitchell, Cedar Park, TX (US)

(73) Assignee: International Business Machines Corporation, Armonk, NY (US)

(21) Appl. No.: 13/103,287

(22) Filed: May 9, 2011

(51) Int. Cl. G06F 17/30

(52) U.S. Cl. 707/694; 707/E17.005

(57) ABSTRACT

A solution for managing data compliance for a set of data repositories in an automated/semi-automated manner is provided. A data repository profile for each data repository can be used to identify a scanning component corresponding to the data repository, which can be launched to identify any suspect data items stored in the data repository. Subsequently, an identified suspect data item can be evaluated for compliance with one or more compliance policies of the corresponding data repository, which also can be stored in the repository profile. When the suspect data item is evaluated as being in violation of one or more compliance policies, a set of corrective actions stored in the repository profile can be identified and initiated to address the violation.

### TECHNICAL FIELD

The disclosure relates generally to data compliance management, and more particularly, to a semi-automated/automated solution for managing data compliance for a set of data repositories of an organization.

### BACKGROUND ART

Organizations (e.g., business entities) and their personnel possess/produce a large amount of electronic data, which the organizations often desire to be stored/housed and managed in central locations. As a result, Content Management (CM) repositories are an important component for data exchange and data sharing in today's organizations. In order to strengthen collaboration and distribution of material within/by an organization, it is often desirable to provide multiple styles of content management, each of which is conducive to distributing data in a unique manner. As a result, an organization often will have a variety of heterogeneous content management systems. These content management systems can be specific to a portion of the organization (e.g., a department) or managed across the entire organization.

The content stored within these content management systems can be wide ranging, including, for example, blogs, documents, presentations, audiovisual media, and/or the like. Furthermore, the content can comprise different security requirements, such as confidential content, public content, internal content, and/or the like. An organization can comprise a distinct content management system for managing content having each security requirement. Additionally, a content management system can comprise multiple zones, each of which corresponds to content having a common security requirement. In either case, personnel of an organization are required to add their electronic data to the appropriate content management system or in the appropriate zone within a content management system according to the security requirements for the data. However, personnel can make mistakes when adding data to one of multiple content management systems/zones. As a result, an organization often desires a solution for confirming that data added to a content management system conforms with the organization's security guidelines.

Security systems for data centers tend to work on linear content management systems or file systems. Security systems normally work on fixed asset areas with rigid reporting and mitigation management tools. These tools are normally a mix of manual active and automation that still require human intervention. To date, security tools, such as automated security scan software, are purpose built for specific content management systems or file systems. New models for content management systems are continually being developed and the backing store systems supporting those content management systems also are continually changing. The variety of content management systems and backing store solutions present a challenge when it comes to adhering to an organization's security guidelines and today's security tooling systems.

### SUMMARY OF THE INVENTION

The inventors have found that it is not ideal nor cost effective for an organization to include personnel dedicated to inspecting every new content posting in the various content management systems to ensure appropriate compliance with the corresponding content management system's security guidelines. To date, currently available security approaches, at best, can audit the content and move content flagged as being in violation to a sensitive content vault, e.g., a storage location where the content is deemed secured. The inventors have found that this approach severs ties to the content, causes confusion for the content owner, and creates one central location in the organization where all sensitive content must reside. Furthermore, the content owner is not afforded an opportunity to take any corrective actions and/or learn from his/her mistake to avoid future mistakes.

Aspects of the invention provide a solution for managing data compliance for a set of data repositories in an automated/semi-automated manner. A data repository profile for each data repository can be used to identify a scanning component corresponding to the data repository, which can be launched to identify any suspect data items stored in the data repository. Subsequently, an identified suspect data item can be evaluated for compliance with one or more compliance policies of the corresponding data repository, which also can be stored in the repository profile. When the suspect data item is evaluated as being in violation of one or more compliance policies, a set of corrective actions stored in the repository profile can be identified and initiated to address the violation.

A first aspect of the invention provides a computer-implemented method of managing data compliance, the method comprising: identifying a scanning component corresponding to a data repository using a computer system including at least one computing device, wherein the identifying includes obtaining identification data corresponding to the scanning component from a data repository profile for the data repository; launching the scanning component using the computer system, wherein the scanning component identifies any suspect data items stored in the data repository; evaluating a suspect data item in the data repository for compliance with a set of compliance policies of the data repository using the computer system, wherein the evaluating includes obtaining data corresponding to the set of compliance policies of the data repository from the data repository profile; identifying a set of corrective actions for the suspect data item using the computer system in response to evaluating the suspect data item as being in violation of at least one of the set of compliance policies of the data repository, wherein the identifying includes obtaining data corresponding to the set of corrective actions from the data repository profile; and initiating the set of corrective actions using the computer system.

A second aspect of the invention provides a system comprising: a computer system including at least one computing device, wherein the computer system manages data compliance by performing a method comprising: identifying a scanning component corresponding to a data repository, wherein the identifying includes obtaining identification data corresponding to the scanning component from a data repository profile for the data repository; launching the scanning component, wherein the scanning component identifies any suspect data items stored in the data repository; evaluating a suspect data item in the data repository for compliance with a set of compliance policies of the data repository, wherein the evaluating includes obtaining data corresponding to the set of compliance policies of the data repository from the data repository profile; identifying a set of corrective actions for the suspect data item in response to evaluating the suspect data item as being in violation of at least one of the set of compliance policies of the data repository, wherein the identifying includes obtaining data corresponding to the set of corrective actions from the data repository profile; and initiating the set of corrective actions.

A third aspect of the invention provides a computer program comprising program code embodied in at least one computer-readable medium, which when executed, enables a computer system to implement a method of managing data compliance, the method comprising: identifying a scanning component corresponding to a data repository, wherein the identifying includes obtaining identification data corresponding to the scanning component from a data repository profile for the data repository; launching the scanning component, wherein the scanning component identifies any suspect data items stored in the data repository; evaluating a suspect data item in the data repository for compliance with a set of compliance policies of the data repository, wherein the evaluating includes obtaining data corresponding to the set of compliance policies of the data repository from the data repository profile; identifying a set of corrective actions for the suspect data item in response to evaluating the suspect data item as being in violation of at least one of the set of compliance policies of the data repository, wherein the identifying includes obtaining data corresponding to the set of corrective actions from the data repository profile; and initiating the set of corrective actions.

A fourth aspect of the invention provides a method of generating a computer system for managing data compliance, the method comprising: providing a computer system operable to: identifying a scanning component corresponding to a data repository, wherein the identifying includes obtaining identification data corresponding to the scanning component from a data repository profile for the data repository; launching the scanning component, wherein the scanning component identifies any suspect data items stored in the data repository; evaluating a suspect data item in the data repository for compliance with a set of compliance policies of the data repository, wherein the evaluating includes obtaining data corresponding to the set of compliance policies of the data repository from the data repository profile; identifying a set of corrective actions for the suspect data item in response to evaluating the suspect data item as being in violation of at least one of the set of compliance policies of the data repository, wherein the identifying includes obtaining data corresponding to the set of corrective actions from the data repository profile; and initiating the set of corrective actions.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative computing environment for managing data compliance for a set of data repositories according to an embodiment.

FIG. 2 shows a data flow diagram for an illustrative computing environment according to an embodiment.

FIG. 3 shows an illustrative process for registering a data repository according to an embodiment.

FIG. 4 shows an illustrative process for managing data compliance for a registered data repository according to an embodiment.

FIG. 5 shows an illustrative process for scanning a data repository according to an embodiment.

FIG. 6 shows an illustrative process for addressing a violation of a compliance policy according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for managing data compliance for a set of data repositories in an automated/semi-automated manner. A data repository profile for each data repository can be used to identify a scanning component corresponding to the data repository, which can be launched to identify any suspect data items stored in the data repository. Subsequently, an identified suspect data item can be evaluated for compliance with one or more compliance policies of the corresponding data repository, which also can be stored in the repository profile. When the suspect data item is evaluated as being in violation of one or more compliance policies, a set of corrective actions stored in the repository profile can be identified and initiated to address the violation. As used herein, unless otherwise noted, the term “set” means one or more (i.e., at least one) and the phrase “any solution” means any now known or later developed solution.

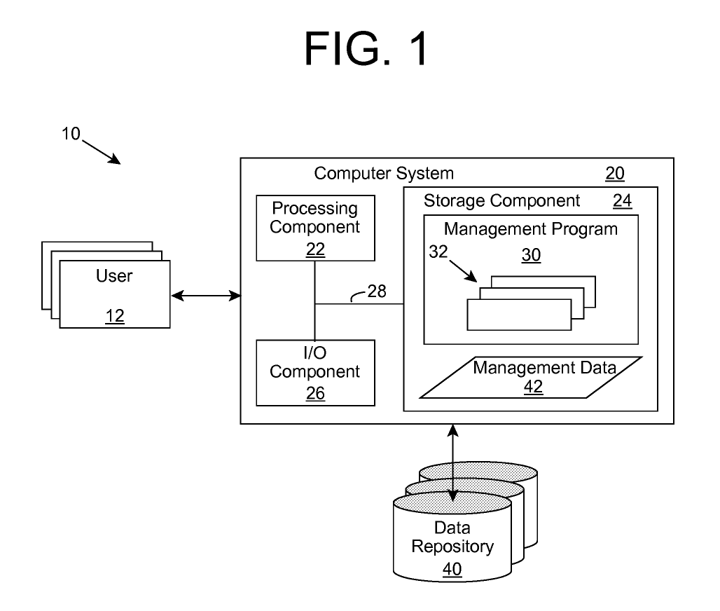

Turning to the drawings, FIG. 1 shows an illustrative computing environment 10 for managing data compliance for a set of data repositories 40 according to an embodiment. In general, a data repository 40 can comprise any type of content management system (CMS), electronic storage space (e.g., a folder and various sub-folders of a directory), and/or the like, which can include data item(s) required to conform to one or more data compliance rules of an organization. To this extent, users 12 associated with the organization will create, edit, move, delete, and/or the like, data items within the data repository(ies) 40 as part of performing their duties for the organization. In general, the users 12 are expected to be aware of and conform to the compliance requirements for the data items and the data repositories 40. For example, a user 12 can be expected to place a secure data item within a secure data repository 40 and/or a secure area of a data repository 40. However, users 12 can make mistakes when manipulating data items within a data repository 40, thereby violating one or more of the compliance requirements.

To this extent, environment 10 includes a computer system 20 that can perform a process described herein in order to manage data compliance for each data repository 40 using management data 42 corresponding to the data repository 40. In particular, computer system 20 is shown including a management program 30, which makes computer system 20 operable to manage data compliance for each data repository 40 using the management data 42 by performing a process described herein.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as management program 30, which is at least partially fixed in storage component 24. While executing program code, processing component 22 can process data, which can result in reading and/or writing transformed data from/to storage component 24 and/or I/O component 26 for further processing. Pathway 28 provides a communications link between each of the components in computer system 20. I/O component 26 can comprise one or more human I/O devices, which enable a human user 12 to interact with computer system 20 and/or one or more communications devices to enable a system user 12 to communicate with computer system 20 using any type of communications link. To this extent, management program 30 can manage a set of interfaces (e.g., graphical user interface(s), application program interface, and/or the like) that enable human and/or system users 12 to interact with management program 30. Further, management program 30 can manage (e.g., store, retrieve, create, manipulate, organize, present, etc.) the data, such as management data 42, using any solution.

In any event, computer system 20 can comprise one or more general purpose computing articles of manufacture (e.g., computing devices) capable of executing program code, such as management program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, management program 30 can be embodied as any combination of system software and/or application software.

Further, management program 30 can be implemented using a set of modules 32. In this case, a module 32 can enable computer system 20 to perform a set of tasks used by management program 30, and can be separately developed and/or implemented apart from other portions of management program 30. As used herein, the term “component” means any configuration of hardware, with or without software, which implements the functionality described in conjunction therewith using any solution, while the term “module” means program code that enables a computer system 20 to implement the actions described in conjunction therewith using any solution. When fixed in a storage component 24 of a computer system 20 that includes a processing component 22, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, each computing device can have only a portion of management program 30 fixed thereon (e.g., one or more modules 32). However, it is understood that computer system 20 and management program 30 are only representative of various possible equivalent computer systems that may perform a process described herein. To this extent, in other embodiments, the functionality provided by computer system 20 and management program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

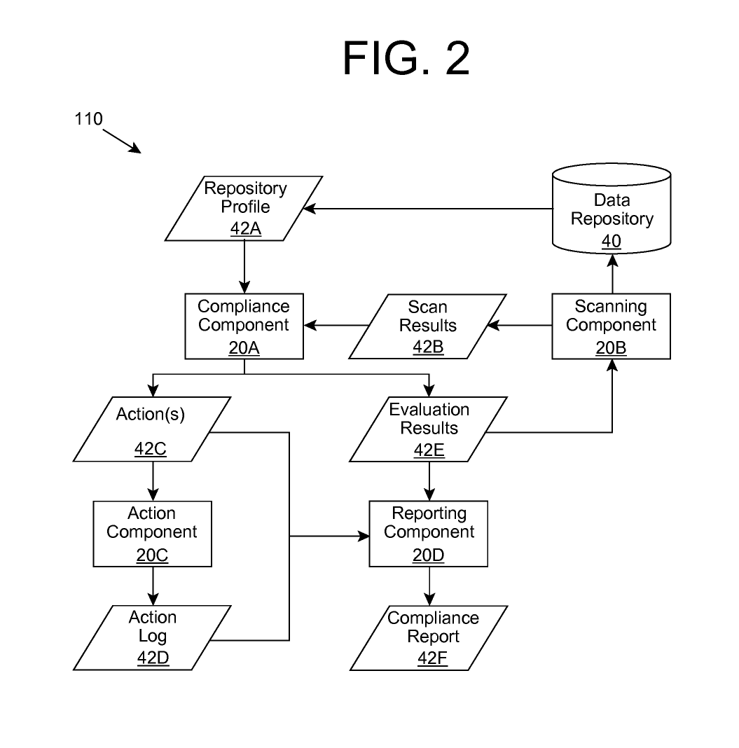

Additional aspects of the invention are shown and described with reference to FIG. 2, which shows a data flow diagram for an illustrative computing environment 110 according to an embodiment. As illustrated, computing environment 110 includes various components 20A-20D, each of which can be implemented by, for example, the computer system 20 of FIG. 1. Similarly, the various components are shown generating and processing various types of management data 42A-42F, which correspond to the management data 42 of FIG. 1. As illustrated, the management data 42 can comprise various data relating to configuration information for a data repository 40 as well as data corresponding to one or more violations and/or actions relating to the violations for the data repository 40. It is understood that the data 42A-42F can be managed by the corresponding component(s) 20A-20D using any solution. For example, the data 42A-42F can be stored and accessed as one or more records in a database, such as a relational database.

In general, a compliance component 20A manages data compliance for one or more data repositories 40 of an organization using repository profile data 42A for each repository 40. To this extent, based on the repository profile 42A, the compliance component 20A can launch one or more scanning components 20B to scan data items stored in the repository 40 for potential violations of one or more compliance rules corresponding to the repository 40 and/or the organization. The scanning component 20B can identify new/modified data items stored in the repository 40 since a previous scan and automatically analyze and/or classify each data item using tagged data, keywords, and/or the like, included in the data item. The compliance component 20A can receive scan results 42B generated as a result of the scanning component 20B scanning the repository 40. The scan results 42B can include data corresponding to one or more data items in the repository 40 suspected of violating one or more compliance rules based on the classification performed by the scanning component 20B.

The compliance component 20A can evaluate the suspect data item(s) identified in the scan results 42B using a set of compliance policies for the repository 40, which are identified in the corresponding repository profile 42A. When the compliance component 20A evaluates the suspect data item as being in violation of one or more of the set of compliance policies, compliance component 20A can identify a set of corrective actions 42C for the suspect data item using data corresponding to the set of corrective actions 42C, which is stored in the repository profile 42A for the repository 40. Compliance component 20A can initiate the set of corrective actions 42C, e.g., by providing data corresponding to the set of corrective actions 42C for processing by one or more corresponding action components 20C. An action component 20C can manage the performance of one or more of the set of corrective actions 42C and log a result of each corrective action 42C in an action log 42D.

Regardless, the compliance component 20A also can generate a set of evaluation results 42E based on the evaluation of the suspect data item(s). The evaluation results 42E can be utilized by the scanning component 20B, e.g., to suppress future re-identification of a modified data item as being suspect for the same reasons that were previously evaluated and found to be in compliance with all of the set of compliance policies. Additionally, a reporting component 20D can use the action(s) 42C, action log 42D, and/or evaluation results 42E to generate one or more of various types of compliance reports 42F for use by a user 12 (FIG. 1). Illustrative compliance reports 42F can include reports directed to a particular repository 40, user/group of related users, all repositories 40 for an organization, types of violations, number of pending violations, and/or the like.

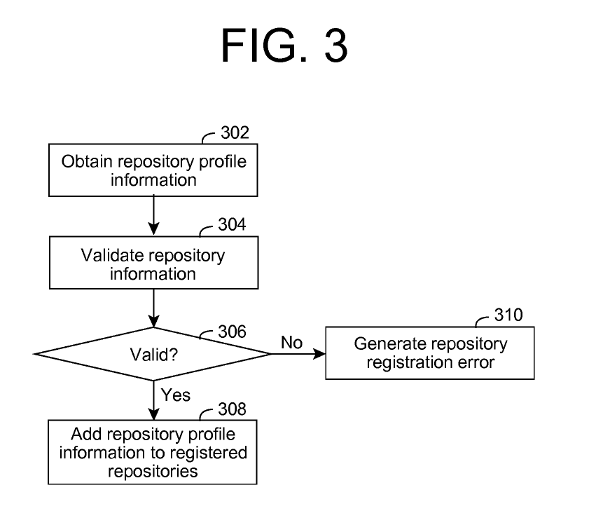

In order to manage data compliance for a repository 40, compliance component 20A can register the data repository 40. The registration process can result in generation of the repository profile 42A corresponding to the data repository 40. FIG. 3 shows an illustrative process for registering a data repository 40 according to an embodiment, which can be implemented by computer system 20.

Referring to FIGS. 1-3, in process 302, computer system 20 (e.g., compliance component 20A) obtains information corresponding to a repository profile 42A for a new data repository 40 for which computer system 20 will manage data compliance. Computer system 20 can obtain various information for creating the data repository profile 42A, which will enable computer system 20 to manage data compliance for data items stored in the data repository 40. Subsequently, computer system 20 can create the data repository profile 42A and store the information therein for use in managing data compliance for the data repository 40. For example, computer system 20 can obtain access information for the data repository 40, which can be stored in the data repository profile 42A. The access information can comprise any type of information, which enables computer system 20 to read and/or write data from/to the data repository 40. Illustrative access information can include a uniform resource identifier (URI), such as a universal resource locator (URL) address, a uniform resource name (URN), and/or the like, for the data repository 40.

Additionally, the information stored in the data repository profile 42A can comprise identification data (e.g., a pointer) corresponding to a set of scanning components 20B to be used in scanning data items stored in the data repository 40. Such identification data can enable computer system 20 (e.g., compliance component 20A) to launch the scanning component(s) 20B in order to scan data items stored in the data repository 40 and identify any suspect data items stored in the data repository 40. A scanning component 20B can be configured for and utilized to scan a single data repository 40, one or more data repositories 40 of a particular type, and/or the like. Additionally, the scanning component 20B can be configured to read the format of data stored in the data repository 40. For example, data can be stored in the data repository 40 using a variety of data formats, such as extensible markup language (XML), comma separated values, portable document format (PDF), and/or the like. In this case, the scanning component 20B can be configured to integrate with the data repository 40, e.g., via an application programming interface (API), or the like, to fetch the data from the data repository 40. In an embodiment, a scanning component 20B comprises a crawler/content fetcher, which is configured to search for new/revised data items, read the format of the data, and/or the like, which are stored in a corresponding data repository 40.

Furthermore, the information stored in the data repository profile 42A can comprise data corresponding to a set of compliance policies for the data repository 40. A compliance policy can define one or more requirements for data items stored in the data repository 40 using any solution. The requirements can correspond to access to the data item, content of the data item, a format type for the data item, and/or the like. The requirements can be defined by the organization, a subset of the organization (e.g., a department), and/or the like. The requirements also can vary based on one or more attributes of the content owner for the data item (e.g., the user 12 that modified/added the data item to the data repository 40), such as his/her job title, department, content privileges, and/or the like. Illustrative compliance policies can limit data items stored in a data repository 40 to only certain types of material (e.g., no sensitive material), only certain author(s), only certain data formats, and/or the like. Similarly, a compliance policy can define a set of analyses to be performed on data items of a particular data format. For example, a compliance policy can define a set of known malware to be searched for within data items of a PDF data format. Any data item found to include such a malware component can be found in violation of the compliance policy.

The information stored in the data repository profile 42A can include data corresponding to a set of corrective processes corresponding to the data repository 40 and/or one or more particular compliance policies for the data repository. A corrective process can include a set of corrective actions 42C to be performed in response to a data item being found in violation of a compliance policy. The corrective actions can include automated, semi-automated, and/or manually implemented actions, such as: one or more interactions with a content owner; suppression, modification, movement, and/or the like, of the data item; production of a report for presentation to an administrator; and/or the like. The corrective actions also can include data indicating whether an owner can be given an extension to correct the violation, and/or the like. Furthermore, the corrective process and/or a corrective action 42C can include data identifying an action component 20C to be utilized in implementing the corrective process and/or corrective action 42C. In an embodiment, a data repository profile 42A can identify a default corrective process to be used in response to a violation, while a compliance policy can define a supplemental and/or alternative corrective process to be performed in response to a violation of the particular compliance policy.

The information stored in the data repository profile 42A can include various other types of information. For example, the information can include data identifying a scan frequency for the data repository 40. The scan frequency can indicate when a new scan of the data repository 40 is required using any solution, e.g., a predetermined time since a previous scan, a triggering event for the scan, and/or the like. Furthermore, the information can include data corresponding to administration information for the data repository 40, e.g., contact information for an individual responsible for maintaining the data repository 40.

Computer system 20 can obtain the information using any manual, automated, or semi-automated solution. For example, in an embodiment, a newly added/configured data repository 40 can automatically broadcast a registration request for processing by the computer system 20. As part of the registration request and/or as part of subsequent communications with computer system 20, the data repository 40 can provide various information enabling the computer system 20 to enable automated creation of the repository profile 42A for the data repository 40. For example, computer system 20 can automatically obtain information from the data repository 40 using one or more standard API calls, and/or the like. To this extent, a data repository 40 can automatically identify, for example, a scanning component 20B (e.g., a crawler), which is capable of scanning data items stored in the data repository 40. Similarly, the data repository 40 can identify a type of data storage solution utilized by the data repository 40, which can enable the computer system 20 to automatically identify an appropriate scanning component 20B for the data repository 40.

In another embodiment, computer system 20 can provide one or more user interfaces, which enable a human user 12 to manually provide some or all of the information for the repository profile 42A. Still further, computer system 20 can automatically discover one or more data repositories 40 using any automated discovery solution, e.g., by periodically polling for new content management systems, and/or the like. For example, computer system 20 can examine network traffic and identify a data storage location to which various users 12 within the organization are uploading data items on a regular basis.

Regardless, after obtaining a sufficient amount of the required information for the repository profile 42A, in process 304, computer system 20 can validate some or all of the information stored in the repository profile 42A. For example, computer system 20 can attempt to launch each scanning component 20B identified in the repository profile 42A to perform a sample scan of the data repository 40 to ensure proper communication with the data repository 40 is enabled by the repository profile 42A. As part of launching the scanning component 20B, computer system 20 can provide the scanning component 20B access information for the data repository 40 included in the repository profile 42A. Similarly, computer system 20 can validate communications with each action component 20C, one or more users 12 associated with the data repository 40, and/or the like.

In process 306, computer system 20 can determine whether the validation action(s) were successful. If so, in process 308, computer system 20 can add the repository profile 42A to a set of registered repositories, and commence managing data compliance for the data repository 40. For example, computer system 20 can indicate that the repository profile 42A for the data repository 40 is valid/active, and its information can be processed accordingly by compliance component 20A to, for example, schedule a scan of the data items in data repository 40. If not, in process 310, computer system 20 can generate a repository registration error for presentation to a user 12, processing by the data repository 40, and/or the like. Subsequently, the registration process can return to process 302 to obtain corrected information, terminate with a failure, and/or the like.

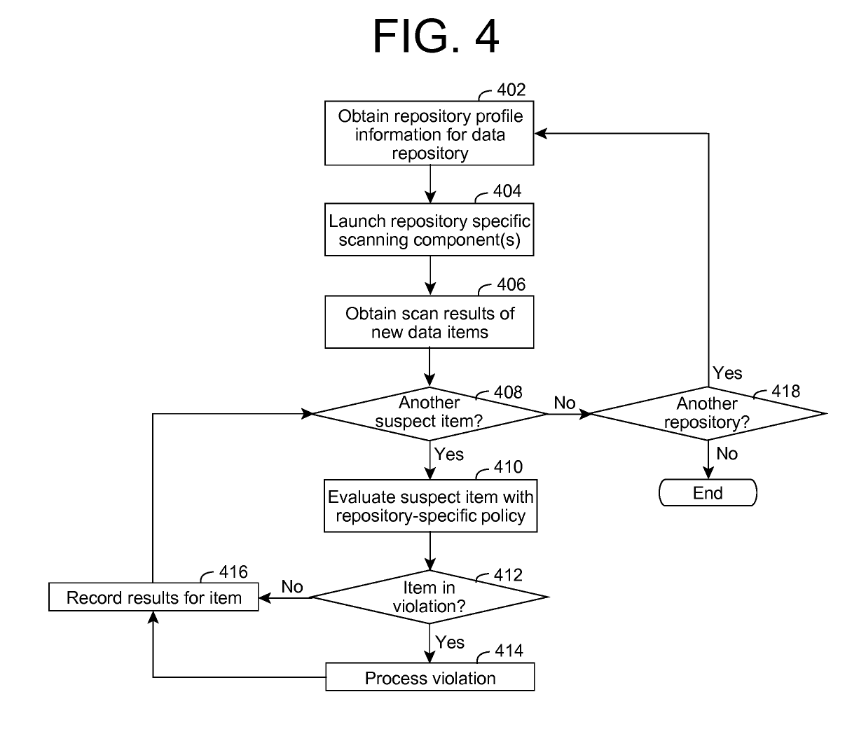

For each registered data repository 40, computer system 20 (e.g., compliance component 20A) can manage data compliance for a set of data items stored in the data repository 40. To this extent, FIG. 4 shows an illustrative process for managing data compliance for a set of registered data repositories 40, which can be implemented by computer system 20 (e.g., compliance component 20A), according to an embodiment. While the process illustrates processing one or more data repositories 40 serially, it is understood that computer system 20 can concurrently manage data compliance for a plurality of data repositories 40. To this extent, the process shown in FIG. 4 can be performed concurrently/in parallel for each of a plurality of data repositories 40. Furthermore, it is understood that the scanning of any data repository 40 can be performed independently from any other data repository 40.

Referring to FIGS. 1, 2, and 4, in process 402, computer system 20 can obtain information used to scan a repository profile 42A for a registered data repository 40 using any solution. Computer system 20 can obtain the information in response to an expired time interval, a request received from a user 12, a data item being added to a data repository 40, and/or the like. In an embodiment, the repository profile 42A includes information defining a time interval between scans of the repository profile 42A, which computer system 20 can use to determine when a scan of the data repository 40 is required. However, it is understood that computer system 20 can use any combination of various solutions for identifying when a scan is required.

In process 404, computer system 20 can launch a set of repository-specific scanning components 20B. A repository profile 42A can define any number of one or more scanning components 20B for a data repository 40. For example, a different scanning component 20B can be utilized for different types of data items stored in the data repository 40. In any event, computer system 20 can provide various data from the repository profile 42A for use by each scanning component 20B in scanning the data repository 40. For example, computer system 20 can provide data identifying the particular data repository 40 to be scanned (e.g., when the scanning component 20B comprises a generic scanning component 20B capable of scanning multiple data repositories), data corresponding to a previous scan, data corresponding to one or more filters, which define types of data items in the data repository 40 that do not require analysis, and/or the like.

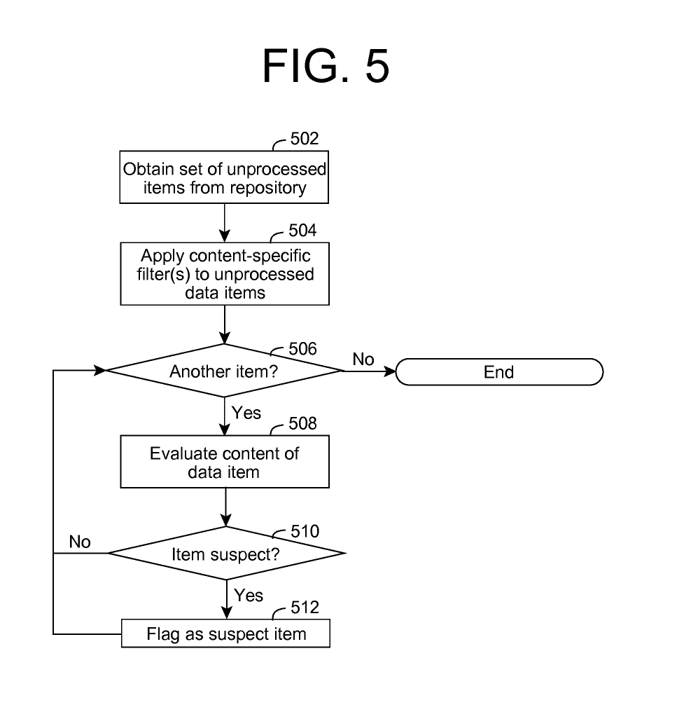

Once launched, the scanning component 20B can scan the data repository 40. To this extent, FIG. 5 shows an illustrative process for scanning a data repository 40, which can be implemented by computer system 20 (e.g., scanning component 20B), according to an embodiment. In process 502, computer system 20 can obtain a set of unprocessed data items from the data repository 40 using any solution, e.g., by iterating through the data items stored in the data repository 40. In an embodiment, the scanning is performed incrementally, in which only data item(s) added/changed since a previous scan are obtained. In another embodiment, the scanning is performed on all data items in the data repository 40. When a data item comprises multiple versions (e.g., when prior versions of a file can be stored in the data repository 40), the scanning can be performed for the current version of the data item as well as one or more previous versions of the data item. Furthermore, previously scanned data item(s) can be re-scanned in response to one or more events, such as a change in one or more policies for the data repository 40. In an embodiment, computer system 20 can consider each version of a data item as a unique data item stored in a data repository 40. In this case, a violation found only in a previous version of a data item will remain until the previous version of the data item is removed from the data repository 40.

In process 504, computer system 20 can apply one or more data repository 40 specific content filters to the set of unprocessed data items. The filter(s) can define a set of data items stored in the data repository 40 to exclude from being evaluated for data compliance. Alternatively, a filter can define a set of data items stored in the data repository 40 that require evaluation for data compliance. For example, a filter can exempt/include content posted by a particular content owner (e.g., chief executive officer), exempt/include posted content having a particular attribute (e.g., secure/public), and/or the like.

For each data item to be processed, computer system 20 can evaluate the content of the data item. To this extent, in process 506, computer system 20 can determine whether another data item of the data repository 40 requires evaluation. If so, in process 508, computer system 20 can evaluate the content of the data item. The evaluation can include, for example, an analysis of the content for the presence of one or more keywords, which may indicate that the data item has been misclassified by the content poster (e.g., confidential content posted publicly), the data item is stored in an incorrect data repository 40, the data item includes inappropriate content, and/or the like. Based on the evaluation, in process 510, computer system 20 can determine whether the data item is suspected of violating one or more policies of the data repository 40. If so, in process 512, computer system 20 can flag the data item as being suspect, thereby requiring further analysis. Computer system 20 can store the results of the data item evaluation as scan results 42B using any solution. For example, the computer system 20 can move the data item to a storage area designated for further processing, include identification information for the data item on a list of data items for further processing, and/or the like. Regardless, after processing the data item, the process can return to process 506 to determine whether another data item requires evaluation. Once all the data items in the data repository 40 have been evaluated, the process can end. For example, the scanning component 20B can stop executing.

Returning to FIG. 4, in process 406, computer system 20 (e.g., compliance component 20A) can obtain the scan results 42B generated by the scanning component 20B. For example, the scan results 42B can be provided by scanning component 20B after the data repository 40 scan has completed. Alternatively, the scan results 42B can be made available for processing by the compliance component 20A as the evaluation of each data item in the data repository 40 is completed. In an embodiment, the scan results 42B include data identifying each of the data items in the data repository 40 that were flagged as being suspect by the scanning component 20B. When multiple scanning components 20B are used to scan a data repository 40, the scan results 42B can be separately generated by each scanning component 20B or a single set of scan results 42B can be generated by all of the scanning components 20B.

Computer system 20 can evaluate each suspect data item identified in the scan results 42B with a set of data repository-specific policies. To this extent, in process 408, computer system 20 can determine whether another suspect data item requires evaluation. If so, in process 410, computer system 20 can evaluate the suspect data item for compliance with a set of data repository-specific compliance policies. As discussed herein, a compliance policy can define one or more requirements for data items stored in the data repository 40. The requirement(s) further can vary based on one or more attributes of the data item, such as a content owner. Regardless, computer system 20 can evaluate the content of the data item for compliance with at least some of the set of compliance policies for the data repository 40 using any solution. In an embodiment, computer system 20 can use a defined order of multiple compliance policies to evaluate the data item (e.g., according to importance, generality, and/or the like). In this case, when computer system 20 determines that the data item violates a compliance policy, computer system 20 may not need to evaluate the data item against additional compliance policies, if any.

In process 412, computer system 20 can determine whether the data item was in violation of any compliance policy for the data repository 40. If so, in process 414, the computer system 20 can process the violation as described herein. In either case, in process 416, the computer system 20 can record the results of the data item evaluation as evaluation results 42E. Subsequently, the process can return to process 408 to determine whether another suspect data item in the data repository 40 requires evaluation. Once all the suspect data items have been evaluated, in process 418, the computer system 20 can determine whether another registered data repository 40 requires scanning and evaluation. If so, processing can return to process 402. Otherwise, the process can end.

As discussed herein, the computer system 20 can generate evaluation results 42E based on the evaluation of each suspect data item stored in a registered data repository 40. The evaluation results 42E can include one or more violation evaluation records indicating that a data item was in violation of one or more compliance policies of the data repository 40. Additionally, the evaluation results 42E can include one or more acceptable evaluation records indicating that a data item was in compliance with all of the compliance policies of the data repository 40. Each evaluation record can include, for example, data corresponding to a date/time of the evaluation, a version of the data item, a version of one or more of the compliance policies used in the evaluation, an evaluation result, and/or the like.

The evaluation results 42E can be utilized in subsequent processing relating to the data repository 40. For example, computer system 20 (e.g., scanning component 20B) can use the evaluation results 42E when subsequently scanning the data repository 40. In an embodiment, the computer system 20 can use acceptable evaluation records included in the evaluation results 42E to suppress additional identifications of the data item as being suspect. In particular, a data item may be re-processed by the computer system 20 during a subsequent scan of the data repository 40 due to, for example, a modification to the data item since a previous scan. Furthermore, the data item may include one or more of the same attributes that caused the data item to be flagged as suspect in the previous scan. In this case, during process 508 (FIG. 5), after identifying the reprocessed data item as being suspect, the computer system 20 can reference an acceptable evaluation record corresponding to the modified data item in the evaluation results 42E to determine whether all of the reasons the reprocessed data item was identified as being suspect were included as reasons the previously processed data item was identified as being suspect. If so, the computer system 20 can suppress identification of the reprocessed data item as being suspect. Otherwise, the reprocessed data item can be identified as suspect and the new reason(s) can be evaluated by the computer system 20 against the compliance policies for the data repository 40. In another embodiment, the suppression described herein can be performed by computer system 20 (e.g., compliance component 20A) as part of the process for evaluating suspect data items for compliance with the set of compliance policies. For example, in process 408 (FIG. 4), the computer system 20 can suppress further processing of the reprocessed suspect data item when no new reasons contributed to its identification as being suspect.

Additionally, the evaluation results 42E can be utilized by the computer system 20 (e.g., reporting component 20D) to generate one or more compliance reports 42F for use by a user 12. For example, computer system 20 can generate a compliance report 42F, which comprises information corresponding to a set of compliance policy violations identified as a result of a scan of the data repository 40. Furthermore, computer system 20 can generate compliance reports 42F using evaluation results 42E for multiple scans, which comprise historical data corresponding to one or more of the data repositories 40. For example, illustrative compliance reports 42F can include data corresponding to a frequency with which each compliance policy is violated, comparisons of violations for multiple data repositories 40, identification of users 12 or groups of users responsible for the most violations, and/or the like.

As discussed herein, the computer system 20 (e.g., compliance component 20A) can process each violation identified in a data repository 40. To this extent, computer system 20 can identify a set of corrective actions 42C to be taken using the repository profile 42A for the data repository. In particular, computer system 20 can obtain data corresponding to the set of corrective actions 42C based on the compliance policy(ies) violated, one or more attributes of the data item (e.g., content owner), and/or the like. In an embodiment, the repository profile 42A can include a set of enforcement policies. Each enforcement policy can include a unique set of corrective actions 42C. In this case, each compliance policy included in the repository profile 42A can include data identifying the corresponding enforcement policy to be utilized in response to a violation of the compliance policy.

Subsequently, computer system 20 can initiate the set of corrective actions 42C to address the violation(s). In an embodiment, the compliance component 20A can provide data corresponding to the set of corrective actions 42C for processing by an action component 20C, which can manage performance of the set of corrective actions 42C. The data can include data identifying each corrective action 42C, data identifying an order for performing a plurality of corrective actions 42C, data required to perform a corrective action 42C (e.g., a content owner/administrator, reason(s) for violation, content of data item in violation, and/or the like), and/or the like. The action component 20C can be scheduler based, in which it executes periodically to determine whether any new violations requiring addressing have been received, any new action results from ongoing violation processing have been received, and/or the like. If nothing has been received, the action component 20C can stop executing for a predetermined period of time. Otherwise, the action component 20C can commence new corrective action(s) 42C in response to the received violation(s)/result(s).

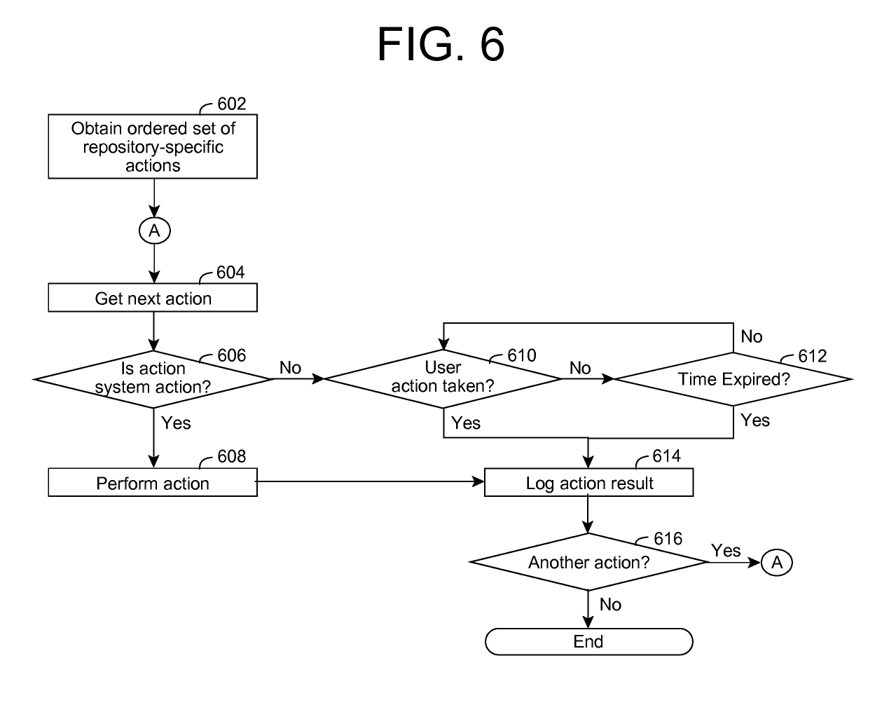

FIG. 6 shows an illustrative process for addressing a violation of a compliance policy, which can be implemented by computer system 20 (e.g., action component 20C), according to an embodiment. In process 602, computer system 20 can obtain an ordered set of repository-specific corrective actions 42C for addressing the violation using any solution (e.g., read from repository profile 42A, provided by compliance component 20A, and/or the like). In process 604, computer system 20 can obtain the next (e.g., first) corrective action 42C to be performed in the set of corrective actions 42C. In process 606, the computer system 20 can determine the type of action of the current corrective action 42C. For example, the corrective action 42C can comprise an action to be performed by the computer system 20 or an action to be performed by a user 12. As discussed herein, the user 12 can comprise a human user (e.g., content owner, administrator, manager, or the like) or another computer system.

When the corrective action 42C comprises a system action, in process 608, the computer system 20 can perform the corrective action 42C. For example, the corrective action 42C can comprise notifying one or more individuals of the violation, automatically correcting the violation (e.g., by quarantining, hiding, cloaking, and/or the like, the data item), and/or the like. In an embodiment, computer system 20 can include an implementation corresponding to each system corrective action 42C, which can be implemented using a high level programming language, such as Java. In this case, the computer system 20 can load the implementation and execute the corrective action 42C, e.g., using an API. Regardless, the computer system 20 can perform the action, e.g., send the notification, quarantine/hide/cloak the data item in violation, after which the data item is not accessible by others or visible to any external sources, and/or the like.

When the corrective action 42C comprises a user action, in process 610, the computer system 20 can initially provide data corresponding to the user action for use by the user 12 in performing the corrective action 42C. For example, computer system 20 can provide a user corrective action 42C request for the violation to a user 12, which requires the user 12 to respond (e.g., after taking some corrective action 42C). The request can comprise a notification enabling a system user 12 to automatically address the violation and report the result, a notification requesting a human user to take some manually action to address the violation and respond that the action is complete, and/or the like.

In any event, a manual corrective action 42C can identify an amount of time within which a response indicating the corrective action 42C has been performed (e.g., two days for a human implemented action). In process 610, the computer system 20 can determine whether the corrective action 42C has been performed. If not, in process 612, the computer system 20 can determine whether the amount of time has expired. If not, processing can return to process 610 (e.g., after a designated “sleep” period has expired). Computer system 20 can continue to wait for the manual action to complete until a response is received and/or the time expires.

Once a corrective action 42C has been performed or the time has expired for performance of a corrective action 42C, in process 614, computer system 20 can log a result of the corrective action 42C in an action log 42D. For example, the result can indicate that the corrective action 42C was successfully performed, one of a plurality of options was selected, the time for the corrective action 42C expired, the corrective action 42C failed, and/or the like.

In process 616, computer system 20 can determine whether another corrective action 42C is required in response to the violation. For example, when an ordered set of corrective actions 42C are defined for the violation, computer system 20 can process the next corrective action 42C in the ordered set, if any. In an embodiment, a set of corrective actions 42C can include alternative execution paths based on the result of a previous corrective action 42C. For example, when a corrective action 42C presents multiple options, the next corrective action 42C can be selected based on the option selected. Similarly, a corrective action 42C may only be required when a previous corrective action 42C failed/was not performed, e.g., when a content owner does not respond to a notification, the next corrective action 42C can be to contact the content owner's manager, automatically quarantine the data item, or the like. Furthermore, when performance of a corrective action 42C fails, resolves the violation, and/or is the last corrective action 42C, computer system 20 can determine that additional corrective actions 42C are not required and computer system 20 can log a resolution result for the violation, status of the violation processing, and/or the like, in the action log 42D.

In an embodiment, computer system 20 can validate the result of a corrective action 42C to determine whether the corrective action 42C was successful. For example, a repository profile for the data repository 40 can define a validator corresponding to a corrective action 42C. In this case, computer system 20 can use the validator to ensure that the corrective action 42C was sufficient. Based on the result returned by the validator, computer system 20 can determine the next corrective action 42C required, if any. In particular, when the validator indicates that the corrective action 42C was insufficient (e.g., a user failed to remove all sensitive content from a data item), the computer system 20 can, for example, restart the set of corrective actions 42C from the beginning, notify the action performer and return to the previous corrective action 42C, and/or the like.

As discussed herein, one or more suspect data items may be incorrectly identified as potentially violating a compliance policy of the data repository 40 by the scanning component 20B. Similarly, the compliance component 20A may incorrectly identify a violation of a compliance policy by the suspect data item. To this extent, the set of corrective actions 42C can include a corrective action which enables a user 14 to indicate that the suspect data item does not violate the compliance policy. In this case, the action component 20C can record a result indicating that an incorrect violation identification. Such a result can be used by computer system 20 to improve identification of compliance policy violation(s). For example, compliance component 20A can adjust one or more attributes of its evaluation of suspect data items for compliance with the compliance policy. Furthermore, computer system 20 can update the evaluation results 42E, which can be used by the scanning component 20B to suppress further identification of the data item as a suspect data item for the same reason(s) when the data item is reprocessed, e.g., due to a modification, as described herein.

The reporting component 20D also can generate one or more compliance reports 42F based on the currently pending corrective action(s) 42C, action log 42D, and/or the like. For example, the reporting component 20D can generate a report illustrating the number of false identifications of compliance policy violations. The report can be broken down by data repository 40, compliance policy, user/user group, and/or the like. Such a report can enable an administrator, or the like, to identify any compliance policies that are not being effectively evaluated, and initiate corrective action to manually improve the evaluation.

The reporting component 20D can generate various types of compliance reports 42F, which can enable users 12 to efficiently address violations of compliance policies by data items stored in a set of data repositories 40. For example, the reporting component 20D can generate a dashboard interface, which can enable a content owner, administrator, or the like, to view all data item(s) in the set of data repositories 40 evaluated as violating one or more compliance policies. For each violation, the dashboard interface can provide the user 12 with an ability to perform a corrective action 42C, indicate that the evaluation was in error, manually correct the violation (e.g., by deleting the data item, moving it to another data repository 40, and/or the like), view a status of a current corrective action 42C, and/or the like. Additionally, the dashboard interface can enable the user 12 to request that the data item be re-scanned after having taken corrective action, request more time to perform a corrective action, manually indicate a violation, and/or the like.

In this manner, computer system 20 can provide a solution for managing the identification of violations/issues related to security (e.g., virus presence) relating to data items stored in any number of heterogeneous data repositories 40 each of which can require a unique scanning solution. The computer system 20 can enable automatic correction of violations, automatic escalation of corrective actions (e.g., due to a delinquent content owner and/or manager), etc. Furthermore, computer system 20 can present a single interface for new data repositories 40 to be registered, a single interface (e.g., notification solution and/or user interface) for allowing users 12 to address violations that may be present in multiple data repositories 40, and/or the like.

To this extent, computer system 20 can unify and centralize the security monitoring and management of dynamic and heterogeneous data repositories 40, which can reside as linear and/or amorphous data repositories. Furthermore, due to its flexibility, computer system 20 can absorb the elasticity introduced with cloud computing. By leveraging the data access methods (e.g., scanning components 20B) provided by the data repositories 40 themselves, computer system 20 can provide a centralized alert and management system that manages the scanning, quarantining, encrypting, and removal (or any other enforcement techniques) of data items across heterogeneous data repositories 40, which can be configured to dynamically register with the computer system 20 with minimal or no human intervention. As a result, computer system 20 can enable data security to be performed in an non-intrusive, more secure manner than other approaches. In particular, computer system 20 can interact with the users 12, such as content owner(s), in an automated fashion to ensure the users 12 are aware of the risk, provide mitigation options, and monitor actions taken by the users 12.

While shown and described herein as a method and system for managing data compliance, it is understood that aspects of the invention further provide various alternative embodiments. For example, in one embodiment, the invention provides a computer program fixed in at least one computer-readable medium, which when executed, enables a computer system to manage data compliance for a set of data repositories 40. To this extent, the computer-readable medium includes program code, such as management program 30 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as management program 30 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for managing data compliance for a set of data repositories 40. In this case, a computer system, such as computer system 20 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer-implemented method of managing data compliance, the method comprising:
identifying a scanning component corresponding to a data repository using a computer system including at least one computing device, wherein the identifying includes obtaining identification data corresponding to the scanning component from a data repository profile for the data repository;
launching the scanning component using the computer system, wherein the scanning component identifies any suspect data items stored in the data repository;
evaluating a suspect data item in the data repository for compliance with a set of compliance policies of the data repository using the computer system, wherein the evaluating includes obtaining data corresponding to the set of compliance policies of the data repository from the data repository profile;
identifying a set of corrective actions for the suspect data item using the computer system in response to evaluating the suspect data item as being in violation of at least one of the set of compliance policies of the data repository, wherein the identifying includes obtaining data corresponding to the set of corrective actions from the data repository profile; and
initiating the set of corrective actions using the computer system.

2. The method of claim 1, further comprising creating an acceptable evaluation record corresponding to the suspect data item in response to evaluating the suspect data item as being in compliance with all of the set of compliance policies of the data repository, wherein the acceptable evaluation record includes a set of reasons the suspect data item was identified as being suspect.

3. The method of claim 2, further comprising scanning the data repository using the scanning component, wherein the scanning includes:
initially identifying a data item stored in the data repository as suspect for a first set of reasons;
comparing the first set of reasons with a set of reasons stored in an acceptable evaluation record corresponding to the data item;
identifying the data item as a suspect data item in response to at least one of the reasons in the first set of reasons not being included in the set of reasons stored in the acceptable evaluation record; and
identifying the data item as a valid data item in response to each of the reasons in the first set of reasons being included in the set of reasons stored in the acceptable evaluation record.

4. The method of claim 1, further comprising creating the data repository profile for the data repository using the computer system, the creating including:
storing access information for the data repository and the identification data corresponding to the scanning component in the data repository profile;
performing a sample scan of the data repository using the identification data and the access information; and
adding the data repository profile to a set of data repository profiles in response to the sample scan being successful.

5. The method of claim 1, wherein the initiating includes:
identifying a first corrective action in the set of corrective actions using the computer system, wherein the data corresponding to the first corrective action indicates whether the action is a system action to be performed by the computer system or a user action to be performed by a user associated with suspect data item;
providing a corrective action request for the user in response to the first corrective action being a user action, wherein the data corresponding to the first corrective action includes data corresponding to the violation notice, contact information for the user, and a time period within which a result of the corrective action request must be received; and
launching a violation action component in response to the first corrective action being a system action, wherein the data corresponding to the first corrective action includes data corresponding to the violation action component.

6. The method of claim 5, further comprising:
obtaining a result for the first corrective action at the violation action component;
adding the result to an action log for the suspect data item using the violation action component; and
automatically initiating a second corrective action based on the set of corrective actions and the result from the first corrective action using the violation action component.

7. The method of claim 6, wherein the obtaining includes:
receiving a first result for the first corrective action from one of the user or the violation action component; and
validating the first result using a validator corresponding to the first corrective action, wherein the validator returns the result for the first corrective action.

8. The method of claim 1, further comprising:
managing a plurality of data repository profiles for a plurality of registered data repositories of an organization using the computer system, wherein each of the plurality of data repository profiles includes a unique set of compliance policies; and
generating a report for presentation to a user using the computer system, wherein the report includes data corresponding to each of a plurality of suspect data items being in violation of at least one compliance policy, wherein the user comprises a content owner for each of the plurality of suspect data items, and wherein the plurality of data items are stored in a plurality of the plurality of registered data repositories.

9. A system comprising:
a computer system including at least one computing device, wherein the computer system manages data compliance by performing a method comprising:
identifying a scanning component corresponding to a data repository, wherein the identifying includes obtaining identification data corresponding to the scanning component from a data repository profile for the data repository;
launching the scanning component, wherein the scanning component identifies any suspect data items stored in the data repository;
evaluating a suspect data item in the data repository for compliance with a set of compliance policies of the data repository, wherein the evaluating includes obtaining data corresponding to the set of compliance policies of the data repository from the data repository profile;
identifying a set of corrective actions for the suspect data item in response to evaluating the suspect data item as being in violation of at least one of the set of compliance policies of the data repository, wherein the identifying includes obtaining data corresponding to the set of corrective actions from the data repository profile; and
initiating the set of corrective actions.

10. The system of claim 9, the method further comprising creating an acceptable evaluation record corresponding to the suspect data item in response to evaluating the suspect data item as being in compliance with all of the set of compliance policies of the data repository, wherein the acceptable evaluation record includes a set of reasons the suspect data item was identified as being suspect and wherein the acceptable evaluation record enables the scanning component to suppress future identification of a modified suspect data item as a suspect data item only for a set of reasons included in the acceptable record.

11. The system of claim 9, wherein the initiating includes:
identifying a first corrective action in the set of corrective actions, wherein the data corresponding to the first corrective action indicates whether the action is a system action or a user action;
providing a corrective action request for a user in response to the first corrective action being a user action, wherein the data corresponding to the first corrective action includes data corresponding to the violation notice, contact information for the user, and a time period within which a result of the corrective action request must be received; and
launching a violation action component in response to the first corrective action being a system action, wherein the data corresponding to the first corrective action includes data corresponding to the violation action component.

12. The system of claim 11, the method further comprising:
obtaining a result from the first corrective action at the violation action component;
adding the result to an action log for the suspect data item using the violation action component; and
automatically initiating a second corrective action based on the set of corrective actions and the result from the first corrective action using the violation action component.

13. The system of claim 12, wherein the obtaining includes:
receiving a first result for the first corrective action from one of the user or the violation action component; and
validating the first result using a validator corresponding to the first corrective action, wherein the validator returns the result for the first corrective action.

14. The system of claim 9, the method further comprising:
managing a plurality of data repository profiles for a plurality of registered data repositories of an organization using the computer system, wherein each of the plurality of data repository profiles includes a unique set of compliance policies; and
generating a report for presentation to a user, wherein the report includes data corresponding to each of a plurality of suspect data items being in violation of at least one compliance policy, wherein the user comprises a content owner for each of the plurality of suspect data items, and wherein the plurality of data items are stored in a plurality of the plurality of registered data repositories.

15. A computer program comprising program code embodied in at least one computer-readable medium, which when executed, enables a computer system to implement a method of managing data compliance, the method comprising:
identifying a scanning component corresponding to a data repository, wherein the identifying includes obtaining identification data corresponding to the scanning component from a data repository profile for the data repository;
launching the scanning component, wherein the scanning component identifies any suspect data items stored in the data repository;
evaluating a suspect data item in the data repository for compliance with a set of compliance policies of the data repository, wherein the evaluating includes obtaining data corresponding to the set of compliance policies of the data repository from the data repository profile;
identifying a set of corrective actions for the suspect data item in response to evaluating the suspect data item as being in violation of at least one of the set of compliance policies of the data repository, wherein the identifying includes obtaining data corresponding to the set of corrective actions from the data repository profile; and
initiating the set of corrective actions.

16. The computer program of claim 15, the method further comprising creating an acceptable evaluation record corresponding to the suspect data item in response to evaluating the suspect data item as being in compliance with all of the set of compliance policies of the data repository, wherein the acceptable evaluation record includes a set of reasons the suspect data item was identified as being suspect and wherein the acceptable evaluation record enables the scanning component to suppress future identification of a modified suspect data item as a suspect data item only for a set of reasons included in the acceptable record.

17. The computer program of claim 15, wherein the initiating includes:
identifying a first corrective action in the set of corrective actions, wherein the data corresponding to the first corrective action indicates whether the action is a system action or a user action;
providing a corrective action request for a user in response to the first corrective action being a user action, wherein the data corresponding to the first corrective action includes data corresponding to the violation notice, contact information for the user, and a time period within which a result of the corrective action request must be received; and
launching a violation action component in response to the first corrective action being a system action, wherein the data corresponding to the first corrective action includes data corresponding to the violation action component.

18. The computer program of claim 17, the method further comprising:
obtaining a result from the first corrective action at the violation action component;
adding the result to an action log for the suspect data item using the violation action component; and
automatically initiating a second corrective action based on the set of corrective actions and the result from the first corrective action using the violation action component.

19. The computer program of claim 15, the method further comprising:
managing a plurality of data repository profiles for a plurality of registered data repositories of an organization using the computer system, wherein each of the plurality of data repository profiles includes a unique set of compliance policies; and
generating a report for presentation to a user, wherein the report includes data corresponding to each of a plurality of suspect data items being in violation of at least one compliance policy, wherein the user comprises a content owner for each of the plurality of suspect data items, and wherein the plurality of data items are stored in a plurality of the plurality of registered data repositories.

20. A method of generating a computer system for managing data compliance, the method comprising:
providing a computer system operable to:
identifying a scanning component corresponding to a data repository, wherein the identifying includes obtaining identification data corresponding to the scanning component from a data repository profile for the data repository;
launching the scanning component, wherein the scanning component identifies any suspect data items stored in the data repository;
evaluating a suspect data item in the data repository for compliance with a set of compliance policies of the data repository, wherein the evaluating includes obtaining data corresponding to the set of compliance policies of the data repository from the data repository profile;
identifying a set of corrective actions for the suspect data item in response to evaluating the suspect data item as being in violation of at least one of the set of compliance policies of the data repository, wherein the identifying includes obtaining data corresponding to the set of corrective actions from the data repository profile; and
initiating the set of corrective actions.
